(19) United States
(12) Patent Application Publication
(10) Pub. No.: US 2025/0173681 A1
(43) Pub. Date: May 29, 2025

(54) PERSISTENT STRUCTURED PERSONAL PROFILE CREATION AND DEVELOPMENT SYSTEM, PLATFORM, AND METHOD

(71) Applicants: Amar Venkata Bukkasagaram, Indianapolis, IN (US); Pavan Kumar Narkulla, Redmond, WA (US)

(72) Inventors: Amar Venkata Bukkasagaram, Indianapolis, IN (US); Pavan Kumar Narkulla, Redmond, WA (US)

(21) Appl. No.: 18/520,729

(22) Filed: Nov. 28, 2023

(51) Int. Cl. G06Q 10/1053; H04L 9/30; H04L 67/306

(52) U.S. Cl. CPC G06Q 10/1053; H04L 9/30; H04L 67/306

(57) ABSTRACT

A method includes receiving, via a network portal, historical user information from a user. The historical user information includes one or more of personal identifying information of the user, education history of the user, or employment history of the user. The method also includes generating an authentication credential for the user. Additionally, the method includes verifying a portion of the historical user information based on information from one or more third-party entities. The method includes generating a trusted data record that includes the portion of the historical user information verified with the one or more third-party entities. Also, the method includes cryptographically securing the trusted data record using the authentication credential of the user.

### BACKGROUND

The present disclosure relates to hiring processes and, more particularly, to a system, platform, and method for creating a persistent, structured, secured, and personal profile, that is portable and referenceable by a profile owner, an authorized current entity, and future entities.

Modern business often involves frequent turnover as employees and employers look for better opportunities for themselves or their business. As part of this turnover, employees and potential employees must repeatedly provide the same information to different employers, and employers must repetitively gather such information. Further, this information is often only temporarily stored by employers and employees, thus creating the need for the information to be gathered or entered again. This necessity for repeated information gathering without persistence of the information results in records that are isolated from the other information contributors and sources. Inaccuracies are thus introduced by the disassociation between information contributors and the nature of temporary information persistence. Without traceable verifiable authoritative sources, the information is very frequently inaccurate and or incomplete.

### SUMMARY

In one aspect of the present disclosure, a method includes receiving, via a network portal, historical user information from a user. The historical user information includes one or more of personal identifying information of the user, education history of the user, or employment history of the user. The method also includes generating an authentication credential for the user. Additionally, the method includes verifying a portion of the historical user information based on information from one or more third-party entities. The method includes generating a trusted data record that includes the portion of the historical user information verified with the one or more third-party entities. Also, the method includes cryptographically securing the trusted data record using the authentication credential of the user.

In another aspect of the present disclosure, a computer-readable medium storing instructions for causing one or more processors to perform a method. The method includes receiving, via a network portal, historical user information from a user. The historical user information includes one or more of personal identifying information of the user, education history of the user, or employment history of the user. The method also includes generating an authentication credential for the user. Additionally, the method includes verifying a portion of the historical user information based on information from one or more third-party entities. The method includes generating a trusted data record that includes the portion of the historical user information verified with the one or more third-party entities. Also, the method includes cryptographically securing the trusted data record using the authentication credential of the user.

In another aspect of the present disclosure, a system includes a communication interface communicating with one or more networks; a memory storing instructions; and one or more processors coupled to the memory and the communication interface and configured to execute the instructions to perform a method. The method includes receiving, via a network portal, historical user information from a user. The historical user information includes one or more of personal identifying information of the user, education history of the user, or employment history of the user. The method also includes generating an authentication credential for the user. Additionally, the method includes verifying a portion of the historical user information based on information from one or more third-party entities. The method includes generating a trusted data record that includes the portion of the historical user information verified with the one or more third-party entities. Also, the method includes cryptographically securing the trusted data record using the authentication credential of the user.

These and other features, aspects and advantages of the present disclosure will become better understood with reference to the following drawings, description, and claims.

### BRIEF DESCRIPTION OF THE DRAWINGS

FIG. 1 shows a schematic diagram of the creation of an embodiment of a profile in accordance with the present disclosure;

FIG. 2 shows a flow chart of a student record use case in accordance with an embodiment of the present disclosure;

FIG. 3 shows a flow chart of an employment record candidate verification use case in accordance with an embodiment of the present disclosure;

FIG. 4 shows a flow chart of a third-party training certified certificate use case in accordance with an embodiment of the present disclosure;

FIG. 5 shows a flow chart of a third-party employment record updates use case in accordance with an embodiment of the present disclosure; and

FIG. 6 shows a schematic diagram of expanded interactions of a credential “profile wallet” in accordance with an embodiment of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As can be seen, there is a need for a persistent profile that employees and employers can reference, with the information being verifiable and trusted. The present disclosure solves these problems by providing system, method, and platform for creating a persistent, structured, secured, and personal wallet profile, that is portable and referenceable by a profile owner, an authorized current entity, and future entities. The present disclosure provides insights into employment history, where data conflicts, where data is duplicated, where data inaccuracies lie, and insights on information that describes relationships between employee and employer. The present disclosure manages the information collection process in a open and transparent manner, while also enforcing the tracible authority of information elements authored into a persisted repository. The present disclosure thereby becomes more accurate, more trusted and immediately verifiably defensible over long periods of time. The present disclosure further provides for the use of information algorithms to generate additional insights about the defined relationships between employers and employees, and possible others.

Broadly, one embodiment of the present disclosure is a system, platform, and method for creating a persistent, structured, secured, and personal profile, that is portable and referenceable by a profile owner, an authorized current entity, and future entities. The present disclosure develops a common, trusted, and accurate centralized employment historical record that is enhanced by using internal logical algorithms across persisted data relationships with individual authorizations to provide insights and recommendations relative to the subject employee.

As stated above, the present disclosure provides insights into employment history, where data conflicts, duplicity and inaccurate information can be contained to describe relationships between employee and employer. The disclosure claimed here solves this problem. By enabling and enforcing logical participation in developing a common, trusted, and accurate centralized employment historical record, enhanced by using internal logical algorithms across the persisted data relationships with individual authorizations to provide insights and recommendations relative to the employee subject.

The present disclosure differs from what currently exists. By providing a single verified and persistent source with traceability to certifying sources, the present disclosure can eliminate many of information inaccuracies and repetitive subject creation integrity problems listed above. The present disclosure is an improvement on what currently exists. current personal profiles are created without pre-reference to persisted and centrally trusted recorded information.

Incomplete records, known and suspected inaccurate records, and un-traceable verification of information open the door to error, and misrepresentation up to and including fraud. The transient and repetitive development nature of existing solutions for the same information represents productivity loss over time. By managing the information collection process in an open and transparent manner, while also enforcing the tracible authority of information elements authored into a persisted repository, over a long period they become more accurate, more trusted, and immediately verifiably defensible. By use of information algorithms, additional insights about the defined relationships can also beneficially be developed By use of artificial intelligence algorithms, parsing across the persisted information records could develop and produce additional valuable insights for additional value-add business purposes.

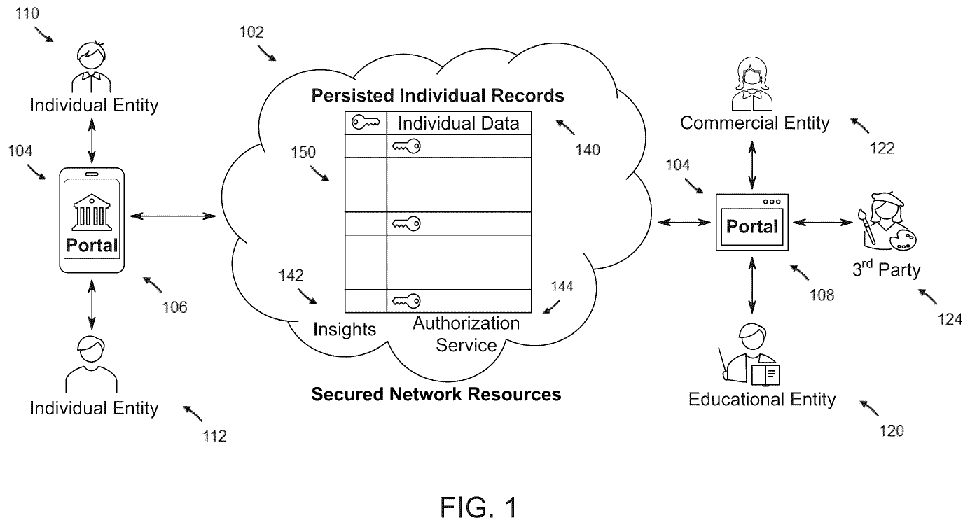

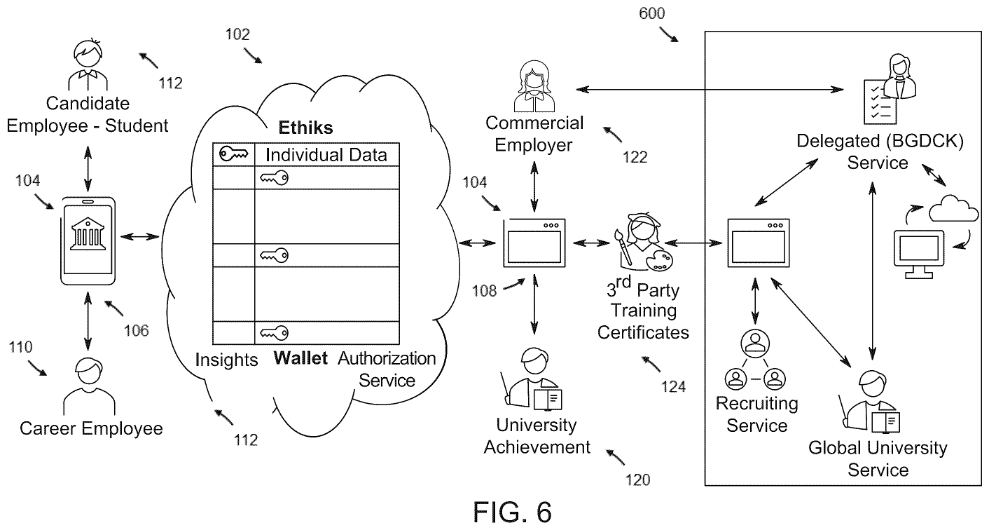

Referring now to FIG. 1-6, FIG. 1 illustrates a network environment 100 including a profile system 102, according to aspects of the present disclosure. The profile system 102, also called “Ethiks”, operates to create a persistent, structured, secured, and personal profile, that is portable and referenceable by a profile owner, an authorized current entity, and future entities. The present disclosure develops a common, trusted, and accurate centralized employment historical record that is enhanced by using internal logical algorithms across persisted data relationships with individual authorizations to provide insights and recommendations relative to the subject employee.

As illustrated in FIG. 1, the profile system 102 can be configured to provide a portal 104 for accessing the profile system 102. In embodiments, the portal 104 can include one or more graphical user interfaces (GUIs) generated by the profile system 102. In embodiments, the portal 104 can include one or more application programming interfaces (APIs) for receiving and outputting data. The portal 104 can be accessed by one or more user devices, for example, a user device 106 and a user device 108, which are communicating with the profile system 102. The user device 106 and/or the user device 108 can include one or more electronic devices such as a laptop computer, a desktop computer, a tablet computer, a smartphone, a thin client, and the like.

In embodiments, various entities can access the services of the profile system 102. For example, the entities can include entities that wish to establish a trusted data record or “wallet” with the system 102 such as trusted prospective employees 110, students 112, and the like. The entities can also include entities that provide verification for the trusted data record and that desire to verify historical data of a user, such as an educational entity 120, a commercial entity 122, and/or some other third party 124.

To perform the process described herein, the profile system 102 can store and execute a records module 140, an insights module 142, and an authorization module 144 to perform the processes and methods described herein. The records module 140, the insights module 142, and the authorization module 144 can be stored in the memory device of the profile system 102. The records module 140, the insights module 142, and the authorization module 144 can include the necessary logic, instructions, and/or programming to perform the processes and methods described herein. The records module 140, the insights module 142, and the authorization module 144 can be written in any programming language.

The memory device 108 can also include a database that stores information and data associated with the process and methods described herein. The database 114 can store a trusted data record 150 for each entity that utilizes the profile system 102.

In embodiments, the trusted data record 150 can include personal identifying information and a number of entries that represent historical data of the user, e.g., student, individual, employee, etc., associated with the trusted data record 150. The historical data can include educational history of the user, employment history of the user, e.g., dates and details of the employment, experience of the user, e.g., skills, talents, level and years of skills and talents, etc., and the like. As described herein, each entry in the trusted data record 150 can be verified by an authority with the requisite knowledge and information to verify the entry. As described herein, the trusted data record 150 can be cryptographically secured, for example, with a key. As described herein, each entry of the trusted data record 150 can be cryptographically secured, for example, with key.

The profile system 102 can also include an interface module that operates to generate and provide graphical user interfaces (GUIs) for the portal 104, for example, menus, widgets, text, images, fields, etc. The GUIs generated by the interface module can be interactive. For example, the GUIs can allow the users of the user devices 106 to enter historical user information to be verified and stored by the profile system 102. In another example, the GUIs can allow entities to verify portions of the historical user information and/or request verification using the trusted data record 150.

For example, the profile system 102, via the portal 104, can then prompt the user to register with the platform and system, and input individual information, such as the user's name, date of birth, social security number, visa number, etc. The records module 140 can then use the individual information to create a profile. The authorization module 144 can then prompt the user to request or authorize validation of the profile by the authorization module 144. Optionally, an entry and verification module can use the profile created by the central persistence module and user request or user authorization received by the authorization module to build and verify a trusted data record 150.

The profile system 102 can request or elect users to participate independently. Users can create a solution identity used to identify and define the authorization and access to information boundaries. Delegation from one user to another is possible, representing delegation of authorization of same restricted access to another user. The profile system 102 generates information requests to user participants to collect and verify information. Information verification is directed to the best knowledgeable resource based on participant definitions and privacy and information security solutions rules. Both entry and maintenance of information include capturing the user credentials for privacy requirements. The profile system 102 utilizes solution-defined processing rules that generate 1 to many information requests to one or many participating users. Discrepancies of information can be anticipated, and a process to remediate is built to allow individuals to challenge informational records. The remediation process to resolve discrepancies repeats the process of requesting individual users to participate in information resolution and remediation. Specific users have access to analytic engine results that provide multiple insights regarding collected and persisted records regarding the information subjects.

The insights module 142 of the profile system 10 can include an analytical insights engine. The analytical insights engine can run algorithms across the information to identify trends, conflicts, concerns, patterns, etc. The analytical insights engine can be adjusted and repeated to derive improved insights. Additional user participants can be gathered to increase the population contained within the central persistent repository of the profile system 102. Additional algorithms could be added or developed on top of the initial product to improve the information insights delivered.

By implementing the solution, multiple benefits and insights are possible. The profile system 102 can identify one dimension of information across a specific user relationship, thereby identifying invalid or inappropriate relationships. The profile system 102 can summarize general populations with specific relationships that can represent trends to be accommodated in business strategies. The profile system 102 can identify dimensional relationships not previously understood that can improve business strategies and decisions. The profile system 102 can create by use of artificial intelligence algorithms, parsing across the persisted information records could develop and produce additional valuable insights for additional value-added business purposes. The parsing can be governed by permitted legal limitations provided under federal and state regulations.

In embodiments, the profile system 102 can include components and/or resources of a computer system, whether physical and/or virtual. For example, the profile system 102 includes a processing device coupled to a communication device. The processing device is also coupled to a memory device, a storage device, and an input/output (“I/O”) interface. The communication interface enables the profile system 102 to communicate with other devices and systems via one or more networks. The profile system 102 can communicate with the user device 106 and/or a user device 108.

The processing device, the communication device, the memory device, the storage device, and the I/O interface can be interconnected via a system bus. The system bus can be and/or include a control bus, a data bus, and address bus, and so forth. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device, the profile system 102 can include multiple processing devices, whether the same type or different types.

The memory device can be and/or include computerized storage medium capable of storing electronic data temporarily, semi-permanently, or permanently. The memory device can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device, the profile system 102 can include multiple memory devices, whether the same type or different types. In embodiments, data stored on the memory devices can be secured using cryptography, for example, encryption protocols and techniques as described herein.

The communication device enables the profile system 102 to communicate with other devices and systems. The communication device can include, for example, a networking chip, one or more antennas, and/or one or more communication ports The communication device can include hardware and/or software for generating and communicating signals over a direct and/or indirect network communication link. The communication device can generate electronic signals and transmit the RF signals via one or more of the communication ports. The communication device can receive the signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received by the networking device.

As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The profile system 102 can communicate with one or more network resources via one or more networks. The one or more network resources can include external databases, social media platforms, search engines, file servers, web servers, or any type of computerized resource that can communicate with the profile system 102 via the one or more networks.

In embodiments, the components and functionality of the profile system 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the profile system 102 can be and/or include a “server” device. The term server can refer to functionality of a device and/or an application operating on a device. For example, an application server can be programming instantiated in an operating system installed on a memory device and run by a processing device. The application server can include instructions for receiving, retrieving, storing, outputting, and/or processing data. A processing server can be programming instantiated in an operating system that receives data, applies rules to data, makes inferences about the data, and so forth. Servers referred to separately herein, such as an application server, a processing server, a collaboration server, a scheduling server, and so forth can be instantiated in the same operating system and/or on the same server device. Separate servers can be instantiated in the same application or in different applications.

The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to unstructured information including audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the profile system 102, the user device 106, and the user device 108, can include a user interface for outputting information in a format perceptible by a user and receiving input from the user. For example, the profile system 102 can communicate with the user interface via the I/O interface 112. The user interface can display graphical user interfaces (“GUIs”) generated by the profile system 102 for the portal 104. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

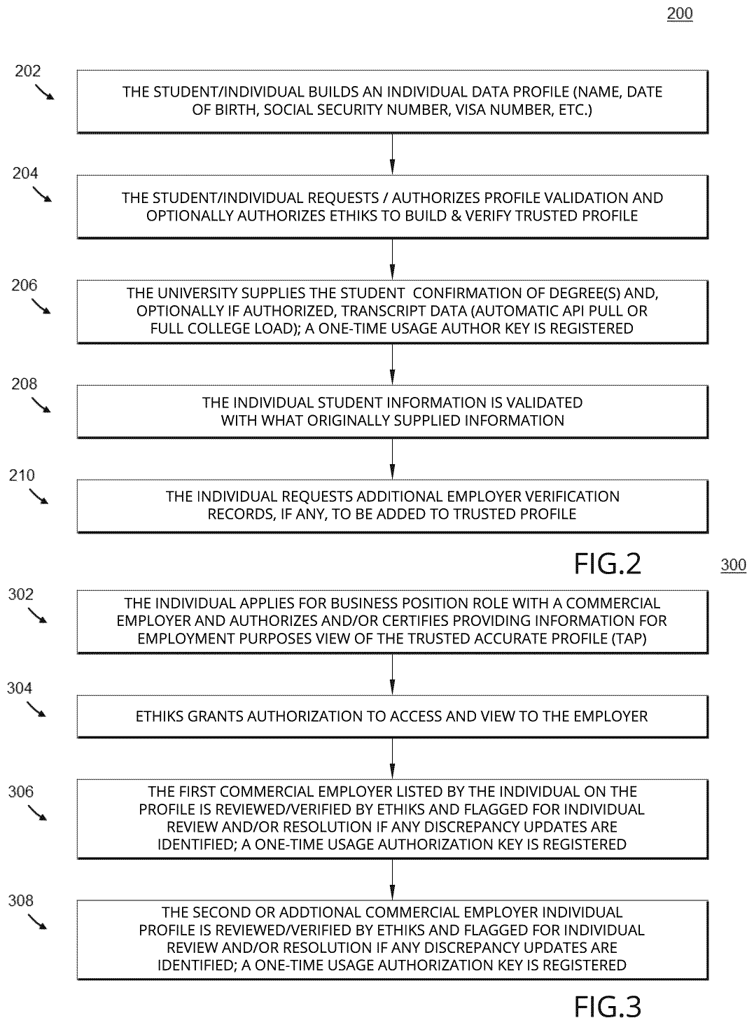

FIG. 2 illustrates a method 200 for a student using the process of the profile system 102. The method 200 creates a persistent, structured, secured, and personal profile, that is portable and referenceable by a profile owner, an authorized current entity, and future entities.

In stage 202, the student and/or individual builds an individual data profile. For example, the individual data profile can include name, date of birth, social security number, visa number, etc. The student and/or individual provides the information to the profile system 102 via the portal 104.

In stage 204, the student and/or individual requests and authorizes profile validation. The student and/or individual can optionally authorize building and verification of a trusted data record or “profile.”

In stage 206, a university or authorized 3^{rd} Party supplies confirmation of the student and/or individual degree(s). Optionally, the university can supply transcript data (e.g., automatically via an API) and/or a full college load. The profile system 102 generates a one-time author key, which is registered.

In stage 208, the information supplied by the student and/or individual is validated against the information supplied by the university. For example, the profile system 102 compare the data supplied against the data provided by the university.

In stage 210, the student and/or individual can request that additional employer verification records, if any, be added to the trusted data record. For example, the profile system 102 can verify the information with employers and add the data to the trusted data record 150.

FIG. 3 illustrates a method 300 for using the process of the profile system 102 in job search and hiring processes.

In stage 302, an individual applies for a business position and/or role with a commercial employer. The individual authorizes and/or certifies providing information for employment purposes from the trusted data record.

In stage 304, the profile system grants authorization and/or access to the employer. The employer can view the contents of the trusted data record.

In stage 306, the profile system reviews the first claimed commercial employer listed by the individual on the trusted data record. If any discrepancies are identified, the individual can be flagged for review and/or resolution. If updates are identified, a one-time usage authorization key is generated and registered.

In stage 308, the profile system reviews the second claimed commercial employer listed by the individual on the trusted data record. If any discrepancies are identified, the individual can be flagged for review and/or resolution. If updates are identified, a one-time usage authorization key is generated and registered. This can be repeated for any number of employers.

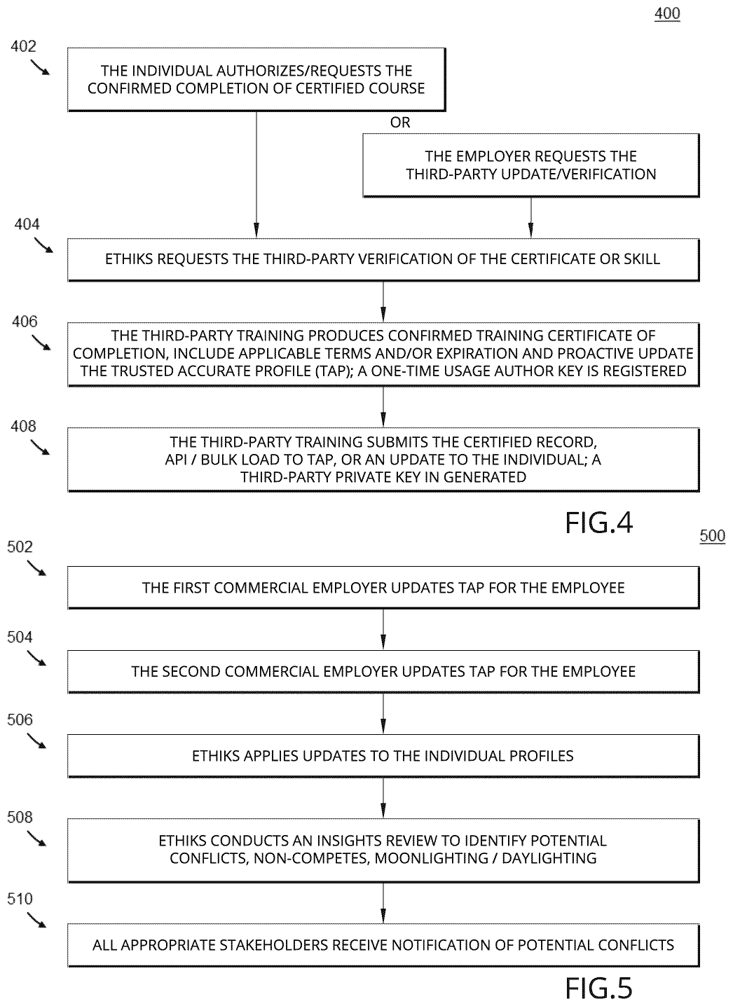

FIG. 4 illustrates a method 400 for using the process of the profile system 102 in verifying third-party courses and certificates.

In stage 402, the individual authorizes and/or requests the confirmed completion of a certified course. The verification and/or update can be requested by an employer of the individual.

In stage 404, the profile system requests the third-party verification of the certification and/or skill. In stage 406, the third-party qualified skills matter expert with training procedures and/or certificate of completion are confirmed. The confirmation can include applicable terms and/or expiration. The profile system can proactively update the trusted data record. A one-time usage author key can be generated and registered for the update.

In 408, optionally, the third-party trainer can submit certified skills or training certificates in bulk, for example, via an API. The profile system can examine the certificates and make updates to the affected trusted data records. A one-time usage author key can be generated and registered for the update.

FIG. 5 illustrates a method 500 for using the process of the profile system 102 in providing analytics for an individual.

In stage 502, a first commercial employer updates a trusted data record for an employee. In stage 504, a second commercial employer updates a trusted data record for the employee. In stage 506, the profile system applies the updates to the trusted data records.

In stage 508, the profile system conducts an insights review to identify potential conflicts, non-competes, moonlighting, and daylighting. The profile system can utilize artificial intelligence and machine learning algorithms to examine the trusted data records.

In stage 510, the profile system sends notification of potential conflicts to all appropriate stakeholders.

The computer-based persistent, structured, secured, and personal profile creation and development platform, system and method described above is for purposes of example only, and can be implemented in any type of computer system or programming or processing environment, or in a computer program, alone or in conjunction with hardware. The present disclosure can also be implemented in software stored on a computer-readable medium and executed as a computer program on a general purpose or special purpose computer. For clarity, only those aspects of the system germane to the disclosure are described, and product details well known in the art are omitted. For the same reason, the computer hardware is not described in further detail. It should thus be understood that the disclosure is not limited to any specific computer language, program, or computer. It is further contemplated that the present disclosure can be run on a stand-alone computer system or run from a server computer system that can be accessed by a plurality of client computer systems interconnected over an intranet network, or that is accessible to clients over the Internet. In addition, many embodiments of the present disclosure have application to a wide range of industries. To the extent the present application discloses a system, the method implemented by that system, as well as software stored on a computer-readable medium and executed as a computer program to perform the method on a general purpose or special purpose computer, are within the scope of the present disclosure. Further, to the extent the present application discloses a method, a system of apparatuses configured to implement the method are within the scope of the present disclosure.

It should be understood, of course, that the foregoing relates to exemplary embodiments of the disclosure and that modifications can be made without departing from the spirit and scope of the disclosure as set forth in the following claims.

What is claimed is:

1. A method, comprising:
receiving, via a network portal, historical user information from a user, wherein the historical user information includes one or more of personal identifying information of the user, education history of the user, or employment history of the user;
generating an authentication credential for the user;
verifying a portion of the historical user information based on information from one or more third-party entities;
generating a trusted data record that includes the portion of the historical user information verified with the one or more third-party entities; and
cryptographically securing the trusted data record using the authentication credential of the user.

2. The method of claim 1, wherein the authentication credential is a private key and a public key of a key pair.

3. The method of claim 1, wherein verifying a portion of the historical user information comprises:
comparing the portion of the historical user information to a repository of certified historical information; and
verifying the portion of the historical user information upon a match with an entry into the repository of certified historical information.

4. The method of claim 1, wherein verifying a portion of the historical user information comprises:
sending a request to the one or more third-party entities, wherein the request includes an identification of the user and the portion of the of the historical user information to be verified;
receiving a verification response from the one or more third-party entities, wherein the verification response is cryptographically secured by the one or more third-party entities; and
verifying the portion of the historical user information upon a positive indication in the verification response.

5. The method of claim 4, further comprising:
if the verification response includes a negative indication, sending a resolution request to the user.

6. The method of claim 1, further comprising:
applying one or more second portions of the historical user information to one or more artificial intelligence algorithms, wherein:
the one or more artificial intelligence algorithms are trained using a predetermined training set of historical user information;
the one or more artificial intelligence algorithms identify potential verification issues in the one or more second portions of the historical user information.

7. The method of claim 1, further comprising:
receiving a verification request from a second user, the verification request identifying the portion of the historical user information to be verified;
requesting authorization to process the request from the user; and
processing the verification request using the trusted data record.

8. A computer-readable medium storing instructions for causing one or more processors to perform a method comprising:
receiving, via a network portal, historical user information from a user, wherein the historical user information includes one or more of personal identifying information of the user, education history of the user, or employment history of the user;
generating an authentication credential for the user;
verifying a portion of the historical user information based on information from one or more third-party entities;
generating a trusted data record that includes the portion of the historical user information verified with the one or more third-party entities; and
cryptographically securing the trusted data record using the authentication credential of the user.

9. The computer-readable medium of claim 8, wherein the authentication credential is a private key and a public key of a key pair.

10. The computer-readable medium of claim 8, wherein verifying a portion of the historical user information comprises:
comparing the portion of the historical user information to a repository of certified historical information; and
verifying the portion of the historical user information upon a match with an entry into the repository of certified historical information.

11. The computer-readable medium of claim 8, wherein verifying a portion of the historical user information comprises:
sending a request to the one or more third-party entities, wherein the request includes an identification of the user and the portion of the of the historical user information to be verified;
receiving a verification response from the one or more third-party entities, wherein the verification response is cryptographically secured by the one or more third-party entities; and
verifying the portion of the historical user information upon a positive indication in the verification response.

12. The computer-readable medium of claim 11, the method further comprising:
if the verification response includes a negative indication, sending a resolution request to the user.

13. The computer-readable medium of claim 8, the method further comprising:
applying one or more second portions of the historical user information to one or more artificial intelligence algorithms, wherein:
the one or more artificial intelligence algorithms are trained using a predetermined training set of historical user information;
the one or more artificial intelligence algorithms identify potential verification issues in the one or more second portions of the historical user information.

14. The computer-readable medium of claim 8, the method further comprising:
receiving a verification request from a second user, the verification request identifying the portion of the historical user information to be verified;
requesting authorization to process the request from the user; and
processing the verification request using the trusted data record.

15. A system, comprising:
a communication interface communicating with one or more networks;
a memory storing instructions; and
one or more processors coupled to the memory and the communication interface and configured to execute the instructions to perform a method comprising:
receiving, via a network portal, historical user information from a user, wherein the historical user information includes one or more of personal identifying information of the user, education history of the user, or employment history of the user,
generating an authentication credential for the user,
verifying a portion of the historical user information based on information from one or more third-party entities,
generating a trusted data record that includes the portion of the historical user information verified with the one or more third-party entities, and cryptographically securing the trusted data record using the authentication credential of the user.

16. The system of claim 15, wherein verifying a portion of the historical user information comprises:
comparing the portion of the historical user information to a repository of certified historical information; and
verifying the portion of the historical user information upon a match with an entry into the repository of certified historical information.

17. The system of claim 15, wherein verifying a portion of the historical user information comprises:
sending a request to the one or more third-party entities, wherein the request includes an identification of the user and the portion of the of the historical user information to be verified;
receiving a verification response from the one or more third-party entities, wherein the verification response is cryptographically secured by the one or more third-party entities; and
verifying the portion of the historical user information upon a positive indication in the verification response.

18. The system of claim 17, wherein the one or more processors execute the instructions to perform the method further comprising:
if the verification response includes a negative indication, sending a resolution request to the user.

19. The system of claim 15, wherein the one or more processors execute the instructions to perform the method further comprising:
applying one or more second portions of the historical user information to one or more artificial intelligence algorithms, wherein:
the one or more artificial intelligence algorithms are trained using a predetermined training set of historical user information;
the one or more artificial intelligence algorithms identify potential verification issues in the one or more second portions of the historical user information.

20. The system of claim 15, wherein the one or more processors execute the instructions to perform the method further comprising:
receiving a verification request from a second user, the verification request identifying the portion of the historical user information to be verified;
requesting authorization to process the request from the user; and
processing the verification request using the trusted data record.
